(19) United States
(12) Patent Application Publication
(10) Pub. No.: US 2009/0127237 A1
(43) Pub. Date: May 21, 2009

(54) DROSS COLLECTING APPARATUS FOR LASER MACHINING DEVICE

(75) Inventor: Koji OZEKI, Inuyama-shi (JP)

Correspondence Address: GLOBAL IP COUNSELORS, LLP, 1233 20TH STREET, NW, SUITE 700, WASHINGTON, DC, 20036-2680, US

(73) Assignee: Murata Machinery, Ltd., Kyoto-shi (JP)

(21) Appl. No.: 12/263,077

(22) Filed: Oct. 31, 2008

(30) Foreign Application Priority Data
Nov. 16, 2007 (JP) 2007-297605

(51) Int. Cl. B23K 26/00

(52) U.S. Cl. 219/121.67

(57) ABSTRACT

The dross collecting apparatus is used in a laser machining device equipped with a laser head provided at a fixed position in the horizontal direction, a sheet material feed mechanism for feeding a sheet material in at least one direction with respect to the laser head, a sheet material table for supporting the sheet material fed by the sheet material feed mechanism, and a frame. The dross collecting apparatus has a dross conveyor for receiving dross generated by laser machining with the laser head and for conveying this dross from the position of the laser head in plan view to a position on the outer periphery of the frame or the outside.

### CROSS-REFERENCE TO RELATED APPLICATIONS

This application claims priority under 35 U.S.C. § 119 to Japanese Patent Application No. 2007-297605 filed on Nov. 16, 2007. The entire disclosure of Japanese Patent Application No. 2007-297605 is hereby incorporated herein by reference.

### BACKGROUND OF THE INVENTION

1. Field of the Invention

The present invention relates to a dross collecting apparatus, and more specifically, the present invention relates to a dross collecting apparatus provided in a laser machining device for collecting the dross generated during laser machining.

2. Background Information

Dross is generated during machining with a laser machining device. To prevent this dross from adhering to the laser head or its surrounding members, a negative pressure chamber is usually provided as a dross collecting apparatus under the laser head. The dross collecting apparatus forcibly sucks the dross downward and discharges it from the peripheral part of the laser head.

With the dross collecting apparatus disclosed in Japanese Laid-Open Patent Application H8-243665, dross that has been drawn in by suction was recovered in a dross collecting vessel disposed directly under the laser head.

Associated with this dross collecting apparatus is a type of laser machining device in which the workpiece is fed by a table. There is a frame surrounding the dross collecting vessel, and a table with a large surface area is provided above the dross collecting vessel. Accordingly, to convey any dross recovered by the dross collecting vessel to the outside, the dross collecting vessel must be replaced. To avoid the surrounding frame, the worker must crawl under the table which is inconvenient. Furthermore, the laser machining device must be shut down while the dross conveyance work is in progress, and this diminishes productivity.

### SUMMARY OF THE INVENTION

One aspect of the present invention is to provide a dross collecting apparatus with a laser machining device so that recovered dross can be easily conveyed to outside of the laser machining device, which will increase the efficiency of the dross conveyance work and raise the productivity of the laser machining device.

The dross collecting apparatus is used in a laser machining device. The laser machining device includes a laser head, a sheet material feed mechanism, and a sheet material table. The laser head is provided at a fixed position in the horizontal direction. The sheet material feed mechanism is provided for feeding a sheet material in at least one direction with respect to the laser head. The sheet material table is provided for supporting the sheet material fed by the sheet material feed mechanism.

The dross collecting apparatus has a dross conveyor arranged to receive dross generated by laser machining with the laser head and to convey this dross generated from a position of the laser head to a position outside of the frame or a position on the outer periphery of the frame.

When dross is generated by the laser head during laser machining and is conveyed away by the dross conveyor, the conveyed dross is recovered by a dross collecting vessel located outside or on the periphery of the frame of the laser machining device. Since the conveyance destination of the dross conveyor is a position to outside of or to the outer periphery of the frame of the laser machining device, the frame does not act as a deterrent when dross is conveyed to the dross collecting vessel, or when it is necessary to replace a loaded dross collecting vessel with an empty dross collecting vessel, so the above-mentioned work can be performed more easily.

According to another aspect of the present invention is to provide the dross collecting apparatus with a negative pressure chamber and a suction apparatus. The negative pressure chamber is formed by blocking off from the outside the lower space of the laser head and the upper space of the dross conveyance face of the dross conveyor. The suction apparatus is provided for drawing air inside of the negative pressure chamber.

According to another aspect of the present invention, the negative pressure chamber includes a blocking mechanism at the upstream end in the conveyance direction and a blocking mechanism at the downstream end in the conveyance direction, the blocking mechanism being arranged to block off the upper space and the outside, at the upstream and downstream ends in the conveyance direction of the upper space of the dross conveyance face.

According to yet another aspect of the present invention, the blocking mechanism at the downstream end includes at least one blocker configured to block off the negative pressure chamber from the outside, retract in the conveyance direction upon receiving external force in the same direction, and return to the blocking position when there is no external force.

According to still another aspect of the present invention, the blocking mechanism at the upstream end includes a wall face, and a plurality of protrusions. The plurality of protrusions are provided on an outer peripheral face of the conveyor and have the same width as the dross conveyor.

According to another aspect of the present invention, the dross conveyor includes a slanted portion that slants upwardly downstream in the conveyance direction.

According to yet another aspect of the present invention, a plurality of protrusions with the same width as the dross conveyor are provided on an outer peripheral face of the dross conveyor.

These and other features, aspects and advantages of the present invention will become apparent to those skilled in the art from the following detailed description, which, taken in conjunction with the annexed drawings, discloses example embodiment of the present invention.

### BRIEF DESCRIPTION OF THE DRAWINGS

Referring now to the attached drawings which form a part of this original disclosure:

FIG. 1 is a front view of the laser machining device pertaining to an embodiment of the present invention;

FIG. 2 is a side view of the laser machining device;

FIG. 3 is a plan view of the laser machining device;

FIG. 4 is a cross section of the dross collecting apparatus of the laser machining device;

FIG. 5 is a plan view of the dross collecting apparatus of the laser machining device;

FIG. 6 is a detail view of the blocking mechanism on the upstream end; and

FIG. 7 is a detail view of the blocking mechanism on the downstream end.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

Configuration of Laser Machining Device

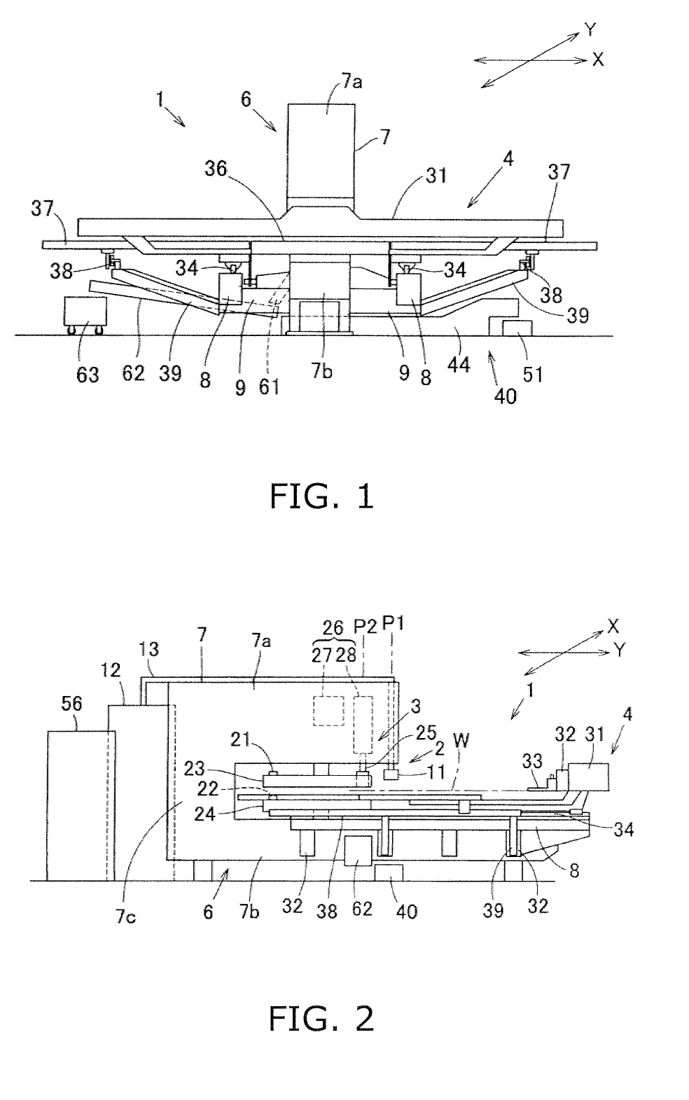

An embodiment of the present invention will be described along with the drawings. FIGS. 1 to 3 are a front view, a side view, and a plan view, respectively, of the overall laser machining device equipped with the dross collecting apparatus of this embodiment. A laser machining device 1 is a composite laser machining device in which a laser machining mechanism 2 (FIG. 2) is combined with a punch press mechanism 3 (FIG. 2). The laser machining device 1 performs laser machining on a sheet material W by way of the laser machining mechanism 2 at a laser machining position P1. The laser machining device 1 also performs punching on the sheet material W by way of the punch press mechanism 3 at a punching position P2. The laser machining position P1 and the punching position P2 are fixed, and the sheet material is fed by a sheet material feed mechanism 4 (discussed below) so that the machining part of the sheet material W supported on a sheet material table 5 will come to the laser machining position P1 or the punching position P2.

A frame 6 of the laser machining device 1 has a main frame 7 in the middle, and a pair of left and right side frames 8 located on the either side thereof. The frame 6 is a structure whose purpose is to support the various configurations of the laser machining device 1 and is the outer frame of the laser machining device 1. The main frame 7 has a sideways-facing U shape when viewed from the side, with the lower side being longer, and is made up of an upper horizontal component 7a, a lower horizontal component 7b, and a vertical component 7c. The main frame lower horizontal component 7b and the side frames 8 are linked by a plurality of linking frames 9.

The laser machining mechanism 2 includes a laser head 11, a laser oscillator 12, and a duct 13. The laser head 11 is disposed at the laser machining position P1, which is located at the distal end of the main frame upper horizontal component 7a. The laser oscillator 12 is disposed on the floor away from the frame 6, and the duct 13 is provided for guiding laser light from the laser oscillator 12 to the laser head 11.

The punch press mechanism 3 has an upper turret 23, a lower turret 24, and a ram 25. The upper and lower turrets 23, 24 are provided between the main frame upper horizontal component 7a and the main frame lower horizontal component 7b. The ram 25 is operatively associated with the main frame upper horizontal component 7a.

The upper turret 23 and the lower turret 24 support an upper tool 21 and a lower tool 22, respectively. The ram 25 drives the tools 21 and 22 of the upper and lower turrets 23, 24 located at the punching position P2. The ram 25 can be moved up and down by a punch drive mechanism 26. The punch drive mechanism 26 has, for example, a servo motor 27 and a motion conversion mechanism 28 for converting the rotation of the motor into linear motion.

The sheet material feed mechanism 4 includes a cross slide 32 and a workpiece holder 33. The cross slide 32 moves left and right (along the X direction) and is installed on a carriage 31 that moves forward and backward (along the Y direction). The workpiece holder 33 is attached to the cross slide 32 and clamps the end of the sheet material W. Guide rails 34 that extend in the forward and backward direction are provided under the carriage 31, and the carriage 31 is moved along the guide rails 34 by a backward and forward feed mechanism (not shown). The cross slide 32 is moved to the left and right with respect to the carriage 31 by a left and right feed mechanism (not shown).

The sheet material table 5 includes a stationary table 36 in the middle and a pair of left and right movable tables 37 disposed on either side of the stationary table 36. The movable tables 37 are integrally attached to the carriage 31. The movable tables 37 move backward and forward together with the carriage 31 along feed rails 38, which extend in the backward and forward direction (along the Y direction). The backward and forward feed rails 38 are supported by support arms 39 that stick out to the side from the outer ends of the linking frames 9.

Configuration of Dross Recovery Apparatus

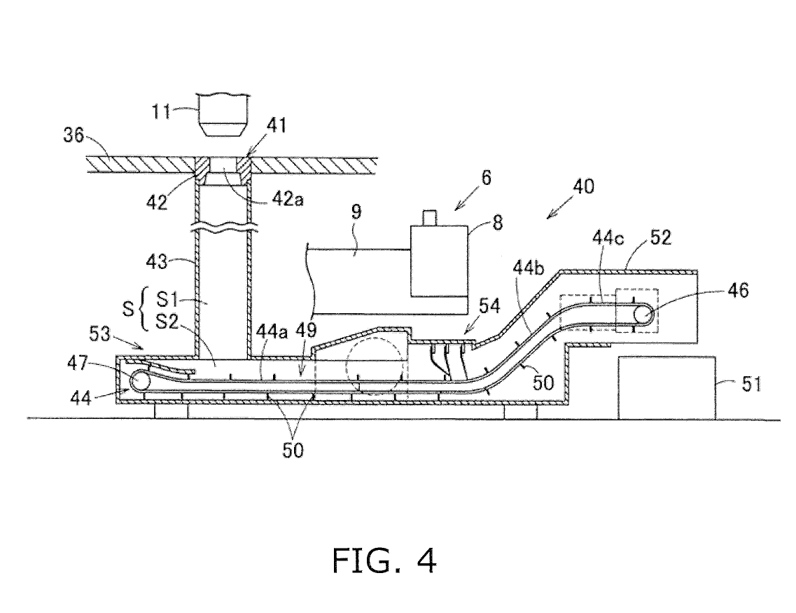

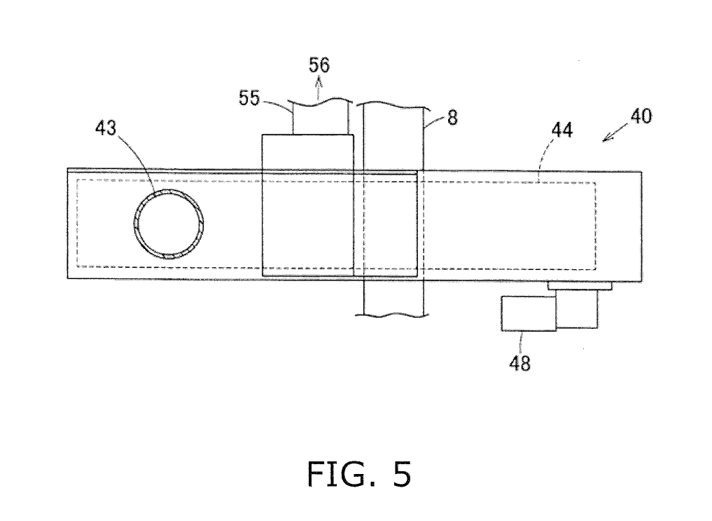

FIGS. 4 and 5 illustrate a dross collecting apparatus 40 for collecting dross generated during laser machining. FIG. 4 is a cross section of the dross collecting apparatus 40, and FIG. 5 is a plan view of the dross collecting apparatus 40. The dross collecting apparatus 40 generally comprises an intake port member 42, a dust collection duct 43, and a dross conveyor 44. The stationary table 36 is provided with an opening 41 to correspond with the lower part of the laser head 11. The intake port member 42, which has an intake port 42a passing through vertically, is fitted into the opening 41. The dust collection duct 43 is provided to the lower side of the intake port member 42. The upper end of the dust collection duct 43 hits the lower face of the intake port member 42 and communicates with the intake port 42a. Furthermore, a dross conveyor 44 is located on the floor below the dust collection duct 43. The dross conveyor 44 receives dross that falls through an internal space S1 of the dust collection duct 43 and conveys it from the position of the laser head 11 in plan view to a position outside of the frame 6.

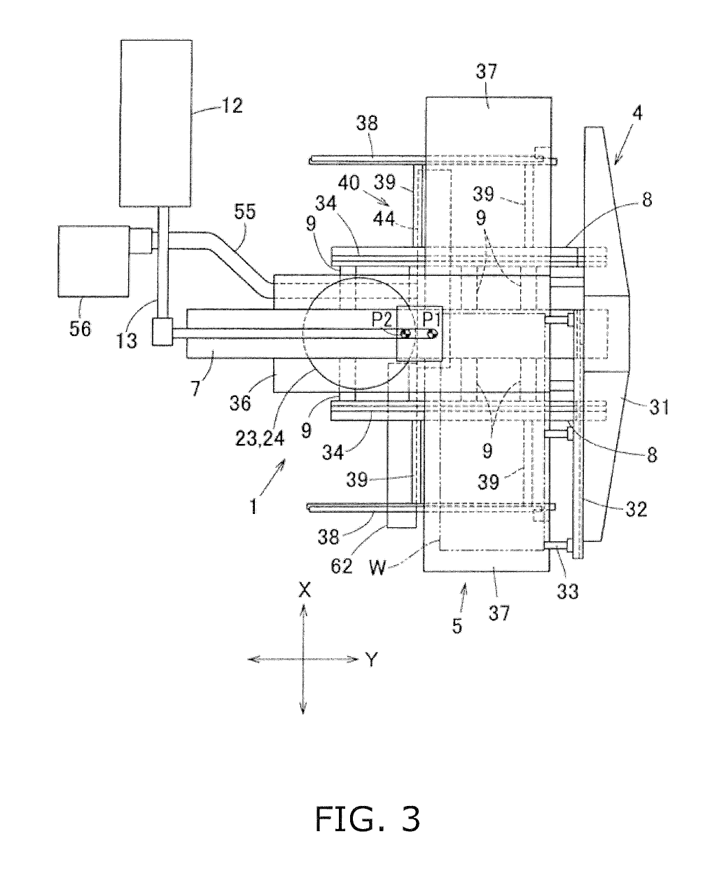

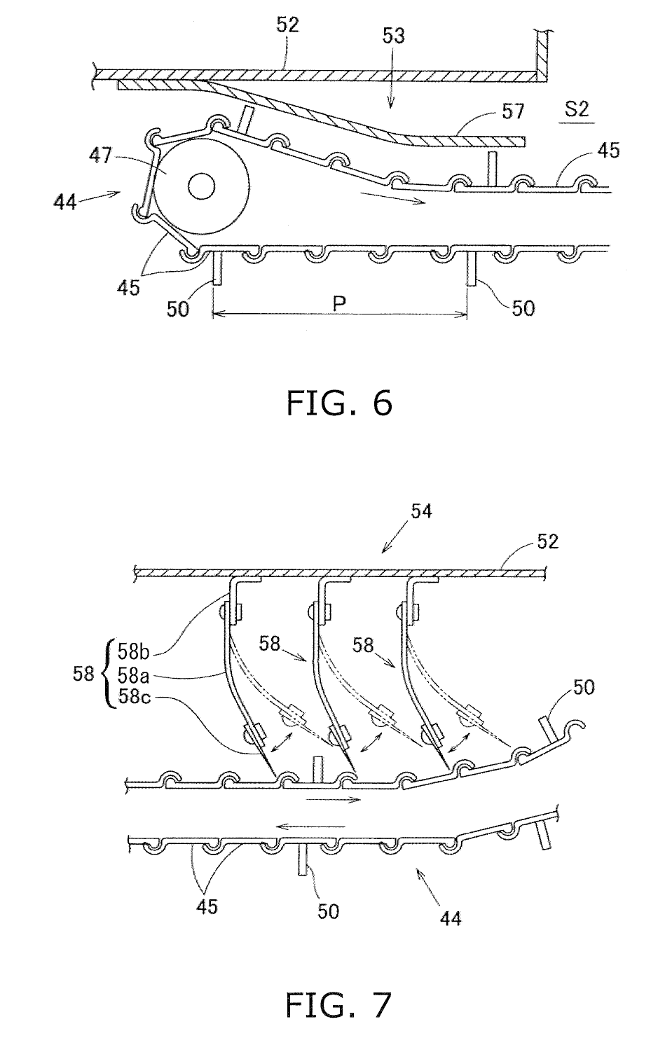

With this embodiment, the conveyance destination of the dross conveyor 44 is between the side frame 8 on the right side and the backward and forward feed rail 38 on the right side (FIGS. 1 and 3). The dross conveyor 44 is a slat conveyor in which a plurality of slats 45 (FIGS. 6 and 7) are linked in an endless loop and is attached to a chain (not shown) wound around a pair of sprockets 46 and 47. When a drive sprocket 46 at the rear end side of a conveyor drive motor 48 is rotated in a specific direction, the upper part of the dross conveyor 44 moves from the front to the rear. The upper face of the upper part of the dross conveyor 44 serves as a dross conveyance face 49, and dross is placed on the dross conveyance face 49 and conveyed. The dross conveyor 44 comprises a horizontal component 44a, a slanted component 44b, and a final end component 44c. The horizontal component 44a accounts for substantially the entire dross conveyor 44. The slanted component 44b of the dross conveyor 44 slants upward downstream and continues in the conveyance direction of the horizontal component 44a. The final end component 44c of the dross conveyor 44 continues from the slanted component 44b towards the downstream conveyance direction.

A plurality of plate-like protrusions 50 of substantially the same width as the slats 45 are attached at equidistant spacing to the outer face of the dross conveyor 44. The plate-like protrusions 50 are provided to prevent the dross on the dross conveyance face 49 from sliding downward in the slanted component 44b of the dross conveyor 44. The final end component 44c of the dross conveyor 44 is raised up from the floor, and a dross collecting vessel 51 is placed on the floor under this final end component 44c for receiving dross that falls from the end of the dross conveyor 44.

The entire dross conveyor 44 is housed in a conveyor case 52. The portion of the conveyor case 52 that continues from the lower end of the dust collection duct 43 is open. Blocking mechanisms 53 and 54 are provided inside the conveyor case 52. The blocking mechanisms 53 and 54 block from the outside the conveyance direction upstream end and downstream end of an upper space S2 of the dross conveyance face 49. As a result, the space consisting of the internal space S1 of the dust collection duct 43, which is considered the lower space of the laser head 1, and the upper space S2 of the dross conveyance face 49 of the dross conveyor 44 functions as a negative pressure chamber S that is blocked off from the outside. The negative pressure chamber S is connected to a suction apparatus 56 via a hose 55 (FIGS. 2 and 3), and when air is drawn into the negative pressure chamber S by the suction apparatus 56, this keeps the negative pressure chamber S in a state of negative pressure. The position where the hose 55 is connected to the negative pressure chamber S is further downstream than the opening to the dust collection duct 43 in the upper space S2 of the dross conveyance face 49.

FIG. 6 is a detail view of the blocking mechanism 53 on the upstream end. A blocking plate 57 that conforms to the shape of the upper part of the dross conveyor 44 is provided as the blocking mechanism 53 on the upstream end. The distance from the upper part of the dross conveyor 44 to the blocking plate 57 is slightly longer (1 mm, for example) than the length of the plate-like protrusions 50. The length of the blocking plate 57 as viewed from the side is greater than the attachment pitch P of the plate-like protrusions 50, and when the dross conveyor 44 is operating, at least one of the plate-like protrusions 50 is always opposite the lower face of the blocking plate 57. The result is that the upstream end of the upper space S2 of the dross conveyance face 49 is blocked off from the outside.

FIG. 7 is a detail view of the blocking mechanism 54 on the downstream end. The blocking mechanism 54 on the downstream end has blockers 58 that in their normal state are in their blocking position at which they block off the negative pressure chamber S from the outside, retract in the conveyance direction upon receiving external force in the same direction, and return to their blocking position when there is no external force. More specifically, the blockers 58 each comprise a support member 58a composed of rubber or another such elastic material, an attachment fitting 58b with which the support member 58a is attached to the roof of the conveyor case 52, and a metal blocking member 58c attached to the lower end of the support member 58a. In FIG. 7, the solid lines indicate a state in which the blockers 58 are in their blocking position, and the two-dot chain lines indicate a state in which the blockers 58 have been retracted by being pushed by the plate-like protrusions 50. In this embodiment, three blockers 58 are provided lined up in the conveyance direction, but there may be more or fewer of the blockers 58.

Also, a chute 61 for discharging punch slug produced by punching is provided under the punching position P2. Further, a punch slug conveyor 62 is provided for conveying punch slug from the lower end of the chute 61 to the outer position of the left side frame 8. A punch slug collecting cart 63 can be stopped under the conveyance end part of the punch slug conveyor 62. With the laser machining device 1, laser machining with the laser machining mechanism 2 and punching with the punch press mechanism 3 are selected according to the material, thickness, machining shape, and so forth of the sheet material W.

Operation of the Dross Recovery Apparatus

The dross collecting apparatus 40 is operated as follows. Dross generated by laser machining is sucked into the dust collection duct 43 through the intake port 42a, and falls onto the dross conveyance face 49 of the dross conveyor 44. The dross that has fallen onto the dross conveyance face 49 of the dross conveyor 44 is conveyed by the dross conveyor 44 to a position between the right side frame 8 and the right backward and forward feed rail 38. The conveyed dross is recovered by the dross collecting vessel 51. When a specified or unspecified amount of dross is recovered by the dross collecting vessel 51, a worker takes the filled dross collecting vessel 51 out of the dross collecting apparatus and replaces it with an empty dross collecting vessel 51.

Since the destination of the conveyed dross is to the dross collecting vessel 51 located outside of the frame 6, the frame 6 does not act as a deterrent, nor does the frame act as a deterrent when it is necessary to replace a fully loaded dross collecting vessel with an empty dross collecting vessel. As such, the above-mentioned work can be performed more easily.

Also, since the destination where the dross is to be conveyed by the dross conveyor 44 is a plan view position near the rear end of the right movable table 37, the above-mentioned work can be carried out without crawling under the movable tables 37, allowing the above-mentioned work to be performed more easily. Thus facilitating the work of dross conveyance shortens the down time of the laser machining device 1 and increases productivity.

In general, when the frame and table are viewed from above, there is a place where the frame sticks out farther than the table, and there is a place where the table sticks out farther than the frame. In view of this, if the destination where the dross is to be conveyed by the dross conveyor is a plan view position where the frame sticks out farther, or is a plan view position where the table sticks out farther, but does not stick out very far, then the dross conveyance work can be carried out without the worker having to crawl under the table, so the dross conveyance work can be carried out more easily. Thus, facilitating the work of dross conveyance shortens the down time of the laser machining device and increases productivity.

Since the space consisting of the internal space S1 of the dust collection duct 43 and the upper space S2 of the dross conveyance face 49 of the dross conveyor 44 functions as a negative pressure chamber S that is kept in a negative pressure state by drawing off the air inside with the suction apparatus 56, the suction of dross through the intake port 42a is carried out favorably. Accordingly, dross can be effectively eliminated from around the laser head 11, and dross can be prevented from adhering to the laser head 11 and its surrounding members.

Since the blocking mechanisms 53 and 54 that block off the negative pressure chamber S from the outside are provided to the conveyance direction upstream end and downstream end of the upper space S2 of the dross conveyance face 49 of the dross conveyor 44, the negative pressure chamber S is sealed more tightly, and this enhances the dross suction effect. The blocking mechanism 54 at the conveyance direction downstream end comprises blockers 58 that in their normal state are in their blocking position at which they block off the negative pressure chamber S from the outside, retract in the conveyance direction upon receiving external force in the same direction, and return to their blocking position when there is no external force. Accordingly, if a large clump of dross or a foreign material other than dross should fall onto the dross conveyance face 49 of the dross conveyor 44, the blockers 58 will be pushed by the clump conveyed by the dross conveyor 44, the blockers 58 will retract in the conveyance direction, and the clump can be allowed to pass. This prevents jamming caused by dross or the like at the conveyance direction downstream end of the upper space S2 of the dross conveyance face 49.

Also, any punch slug produced by punching will be conveyed by the chute 61 and the punch slug conveyor 62 from the lower position of the punching position P2 to a position outside the left side frame 8, and recovered in the punch slug collecting cart 63.

Features

The dross collecting apparatus 40 in an embodiment of the present invention used in the laser machining mechanism 2, which is equipped with the laser head 11 provided at a fixed position in the horizontal direction, a sheet material feed mechanism 4 for feeding a sheet material W in at least one direction with respect to the laser head 11, and a sheet material table 5 for supporting the sheet material W fed by the sheet material feed mechanism 4. The dross collecting apparatus 40 has a dross conveyor 44 for receiving dross generated by laser machining with the laser head 11 and conveying this dross from the position of the laser head 11 in plan view to the outside of the frame 6 or a position on the outer periphery of the frame 6 of the laser machining device 2.

With this apparatus, dross generated during laser machining with the laser head 11 is conveyed by the dross conveyor 44 from the position of the laser head 11 in plan view to the outside of the frame 6 or a position on the outer periphery of the frame 6 of the laser machining mechanism 2. The dross generated during laser machining is recovered in the dross collecting vessel 51, for example, at the destination of this conveyance. Since the destination where the dross is to be conveyed by the dross conveyor 44 is a position to the outside or on the outer periphery of the frame 6 of the laser machining device 1, the frame 6 does not get in the way when the dross is conveyed to the dross collecting vessel 51 located outside of the machine, or when it is necessary to replace a fully loaded dross collecting vessel 51 with an empty dross collecting vessel. As such, the above-mentioned work can be performed more easily.

The dross collecting apparatus 40 further comprises the negative pressure chamber S, in which the lower space of the laser head 11 (the internal space S1 of the dust collection duct) and the upper space S2 of the dross conveyance face 49 of the dross conveyor 44 are blocked off from the outside, and the intake port member 42 for drawing in the air in the negative pressure chamber S and putting the negative pressure chamber S in a state of negative pressure. Therefore, any dross generated during machining is effectively eliminated from around the laser head 11.

The negative pressure chamber S has blocking mechanisms 53 and 54 that block off the upper space S2 from the outside at the conveyance direction upstream end and downstream end of the upper space S2 of the dross conveyance face 49. With this structure, the negative pressure chamber S is sealed more tightly, and this enhances the dross suction effect.

The blocking mechanism 54 at the conveyance direction downstream end has blockers 58 that in their normal state are in their blocking position at which they block off the negative pressure chamber S from the outside, retract in the conveyance direction upon receiving external force in the same direction, and return to their blocking position when there is no external force.

With this apparatus, since the blocking mechanism 54 at the conveyance direction downstream end is able to retract in the conveyance direction, if a large clump of dross or a foreign material other than dross should fall onto the dross conveyance face 49 of the dross conveyor 44, the blockers 58 of the blocking mechanism 54 at the conveyance direction downstream end that are pushed by the clump conveyed by the dross conveyor 44 will retract and allow the clump to pass, so jamming caused by dross or the like at the conveyance direction downstream end can be prevented. That is, the blockers 58 improve the air-tightness of the negative pressure chamber S used for dross suction, and also prevent jamming caused by dross or the like at the conveyance direction downstream end of the negative pressure chamber S.

### OTHER EXAMPLE EMBODIMENTS

In the above embodiment and in plan view, the dross was conveyed by the dross conveyor 44 from the lower position of the laser head 11 to the outside of the frame 6. However, the dross may be conveyed to a position on the outer periphery of the frame 6, in other words, near the outer peripheral edge, including the outer peripheral edge and portions slightly inside of it. Here again, the work of bringing in and taking out of the dross collecting vessel 51 can be performed almost completely without the frame 6 getting in the way.

Also, the laser machining device 1 of the above embodiment is a composite laser machining device in which the punch press mechanism 3 is combined with the laser machining mechanism 2. However, the present invention can also be applied to a laser machining device 1 that does not have the punch press mechanism 3.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A dross collecting apparatus for use in a laser machining device including a frame, a laser head provided at a fixed position in the horizontal direction, a sheet material feed mechanism for feeding a sheet material in at least one direction with respect to the laser head, and a sheet material table for supporting the sheet material fed by the sheet material feed mechanism, the dross collecting apparatus comprising:
a dross conveyor arranged to receive dross generated during laser machining with the laser head and to convey the dross generated from a position proximate to the laser head to a position outside of the frame or the outer periphery of the frame.

2. The dross collecting apparatus according to claim 1, further comprising:
a negative pressure chamber formed by blocking off from the outside the lower space of the laser head and the upper space of the dross conveyance face of the dross conveyor; and
a suction apparatus configured to draw air inside of the negative pressure chamber.

3. The dross collecting apparatus according to claim 2, wherein
the negative pressure chamber includes a blocking mechanism at the upstream end in the conveyance direction and a blocking mechanism at the downstream end in the conveyance direction, the blocking mechanism being arranged to block off the upper space and the outside, at the upstream and downstream ends in the conveyance direction of the upper space of the dross conveyance face.

4. The dross collecting apparatus according to claim 3, wherein
the blocking mechanism at the downstream end includes at least one blocker configured to block off the negative pressure chamber from the outside, retract in the conveyance direction upon receiving an external force in the conveyance direction, and return to the blocking position when there is no external force.

5. The dross collecting apparatus according to claim 3, wherein
the blocking mechanism at the upstream end includes a wall face and a plurality of protrusions, the plurality of protrusions are provided on an outer peripheral face of the conveyor and have the same width as the dross conveyor.

6. The dross collecting apparatus according to claim 1, wherein
the dross conveyor includes a slanted portion that slants upwardly downstream in the conveyance direction.

7. The dross collecting apparatus according to claim 6, wherein
a plurality of protrusions with the same width as the dross conveyor are provided on an outer peripheral face of the dross conveyor.
